(19) United States
(12) Patent Application Publication
(10) Pub. No.: US 2014/0000370 A1
(43) Pub. Date: Jan. 2, 2014

(54) INSPECTION OF COMPOSITE COMPONENTS

(71) Applicants: Andrew Bond-Thorley, Stonehouse (GB); Richard Freemantell, Ashbourne (GB); Luis Rivera, Mould (GB); Andrew Philpot, Wrexham (GB); Alun Williams, Holywell (GB); Arthur O'Mahony, Prestwich (GB)

(72) Inventors: Andrew Bond-Thorley, Stonehouse (GB); Richard Freemantell, Ashbourne (GB); Luis Rivera, Mould (GB); Andrew Philpot, Wrexham (GB); Alun Williams, Holywell (GB); Arthur O'Mahony, Prestwich (GB)

(73) Assignee: AIRBUS OPERATIONS LIMITED, Bristol (GB)

(21) Appl. No.: 14/005,184

(22) PCT Filed: Mar. 9, 2012
(86) PCT No.: PCT/GB12/50533

§ 371 Date: Sep. 13, 2013

(30) Foreign Application Priority Data
Mar. 16, 2011 (GB) 1104409.6

(51) Int. Cl. G01N 29/24

(52) U.S. Cl. CPC G01N 29/24
USPC 73/632

(57) ABSTRACT

A method and apparatus for scanning a workpiece (100) comprises providing an insert (120) insertable within a countersunk bore (106), the insert (120) being acoustically mounted to the workpiece (100) in order to scan regions below the countersunk area.

The present invention is concerned with a method and apparatus for inspecting components constructed from composite materials. More specifically, the present invention is concerned with a method and apparatus for the inspection of regions of material surrounding countersunk bores in composite components.

It is common practice in the manufacture of composite components to form bores with a countersunk feature. This allows mechanical fasteners with heads to be used whilst retaining a smooth or flush outer surface.

A potential risk when drilling bores in composite components is potential delamination due to drilling forces exerted on the bore walls. Blunt drills or unsuitable cutting speeds (either too fast or too slow) may delaminate the fibre layers in the region of the bore hole resulting in areas of weakness. This is particularly problematic in the region of bores, which act as stress raisers.

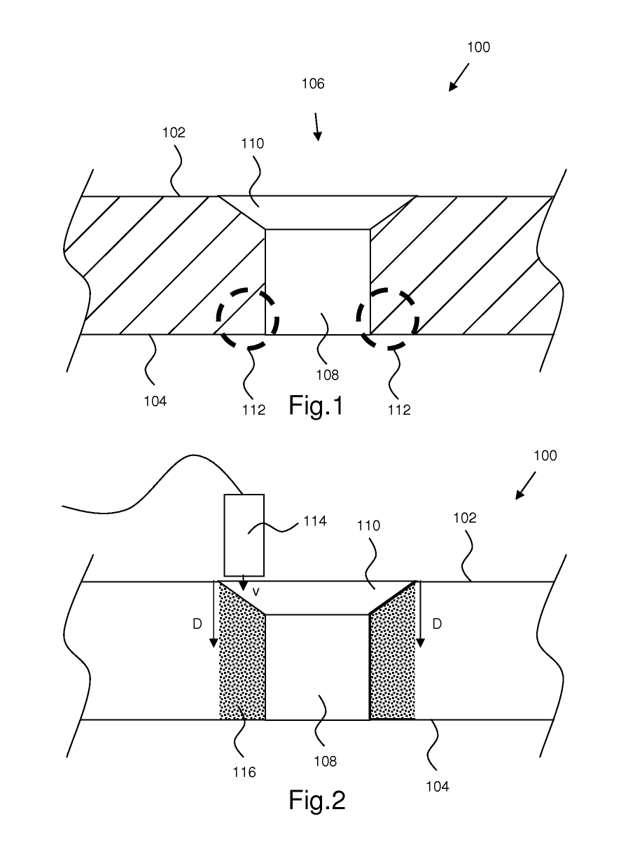

Turning to FIG. 1 of the appended drawings, a composite component 100 is shown in side section having an outer surface 102, an inner surface 104 and a countersunk bore 106 drilled therethrough. The countersunk bore 106 comprises a cylindrical portion 108 and a shallow countersunk formation in the form of a frustro-conical portion 110 opening to the outer surface 102. The bore 106 was drilled from the outer surface 102. Damage (e.g. delamination) may occur in first region 112 surrounding the cylindrical part of the bore 106 proximate the inner surface 104.

Turning to FIG. 2, the component 100 is shown (without cross-hatching for clarity). An ultrasonic probe 114 is presented to the component 100. The ultrasonic probe 114 has a scanning vector V through the thickness of the material directed from the outer side 102 to the inner side 104.

Due to the presence of the countersunk formation (i.e the frustro-conical portion 110), the probe 114 is unable to detect any faults in the first region 116 which is, in effect, “shadowed” by the countersunk formation 110. The first region 116 is the area on the opposite side of the countersunk formation 110 to the outer surface 102 in a direction D normal to the outer surface 102.

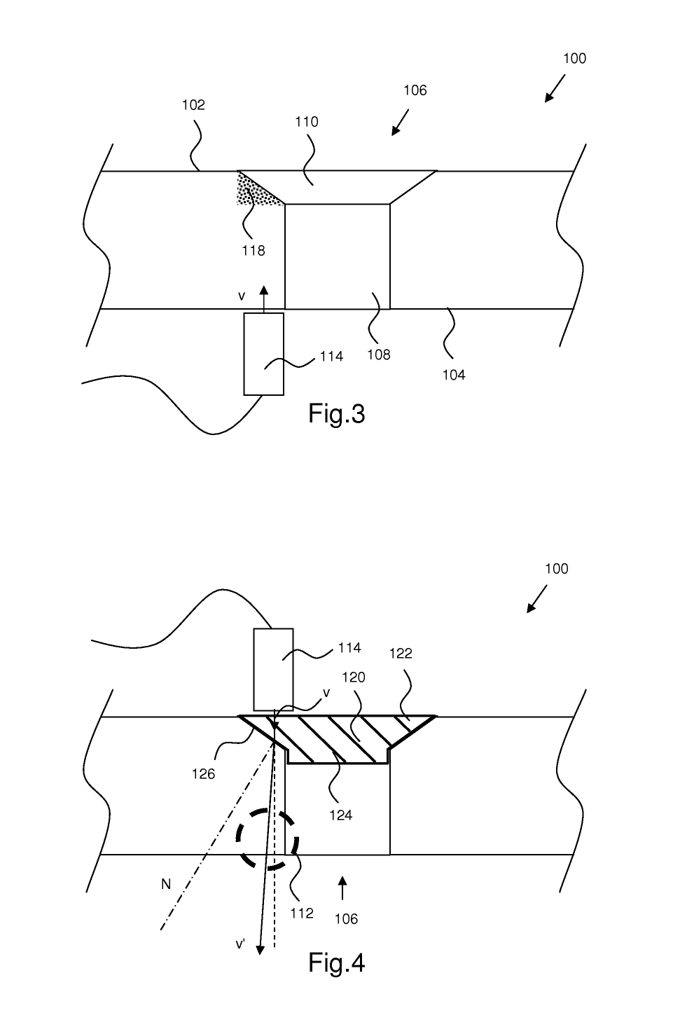

An alternative approach to scanning in the first region 116 of the bore 106 is shown in FIG. 3. The ultrasonic probe 114 is positioned at the inner surface 104. A problem with the approach of FIG. 3 is that a smaller region 118 is still “shadowed” by the frustro-conical portion 110 and is unable to be scanned.

Furthermore, it is not always possible to scan the component 100 from the inner surface 104, particularly if the component is in situ or has an enclosed inner space.

It is an aim of the present invention to at least mitigate the above mentioned problems.

According to the present invention there is provided a method of inspecting a component comprising the steps of:
providing an ultrasonic transducer,
providing a component to be inspected defining a countersunk bore, which countersunk bore defines a countersunk formation open to a first surface of the component, the component having a first region to be inspected on an opposite side of the countersunk formation to the first surface in a direction perpendicular to the first surface,
providing an insert defining a male feature corresponding to the countersunk formation,
engaging the male feature in the countersunk formation to define a boundary between the component and the insert,
directing ultrasonic energy from the transducer, through the insert, across the boundary and into the first region of the component,
inspecting the first region of the component by detecting the ultrasonic energy.

By “countersunk bore”, we mean a bore having a generally cylindrical portion (which may be tapped) and a fastener head receiving portion (the countersunk formation). Most commonly the countersunk formation is frustro-conical, but it will be understood that it can be any suitable shape for receiving the head of a fastener.

The provision of an insert allows the user to bridge the gap between the transducer and the workpiece in the region of the countersunk formation (i.e. from the exterior surface). Therefore the detrimental effect of having a gap between the transducer and the workpiece surface is mitigated.

The method is particularly suited to machined features resulting from manufacturing processes (e.g. drilling) which may damage the workpiece material. The method is particularly well suited to countersunk formations due to the fact they are generally machined and have a “blind spot” directly below the countersunk formation where drilling damage is likely to occur.

Preferably the component is constructed from a laminar composite material, and the female feature is a bore oriented perpendicular to layers of the laminar composite. The method is particularly well suited to detecting damage in composite materials.

Preferably the insert defines a scanning surface which is parallel to a surface of the component in use. This permits the user to scan directly into the workpiece proximate the walls of the female feature where damage is most likely to occur.

Preferably the scanning surface is flush with the surface of the component. A transducer can be swept along the surface in a continuous manner, and does not have to be specially positioned to detect defects proximate the female formation.

Preferably the insert is constructed from a material having a speed of sound similar to that of the component, more preferably the speed of sound of the insert is within 4% of the speed of sound of the component. This reduces any refraction when the sound energy passes from the insert into the workpiece.

According to a second aspect of the invention there is provided an apparatus for inspecting a composite component comprising:
an insert having a male formation corresponding to a countersunk formation for engaging a corresponding countersunk formation of a composite workpiece bore, the insert having a scanning surface for contact with an ultrasonic probe.

Preferably the male formation comprises a cylindrical portion for engaging in the composite workpiece bore.

More preferably the insert defines a probe receiving formation comprising the scanning surface.

Preferably the insert is axisymmetric. By “axisymmetric” we mean “rotationally symmetrical”. This allows the insert to be rotated to form a best fit with the female formation. Should the insert comprise a cavity or formation for receiving a transducer in a discrete position, the insert can be rotated in use to scan the entire periphery of the female formation. Preferably the male formation is shaped to be engageable with a countersunk bore.

A method and apparatus in accordance with the present invention will now be described with reference to the accompanying figures in which:

FIG. 1 is a side section view of a composite component;

FIG. 2 is a side section view of the component of FIG. 1 being scanned from a first direction in accordance with a first prior art method;

FIG. 3 is side section view of the component of FIG. 1 being scanned from a second direction in accordance with a second prior art method;

FIG. 4 is a side section view of the component of FIG. 1 being scanned in accordance with a first embodiment of the present invention; and

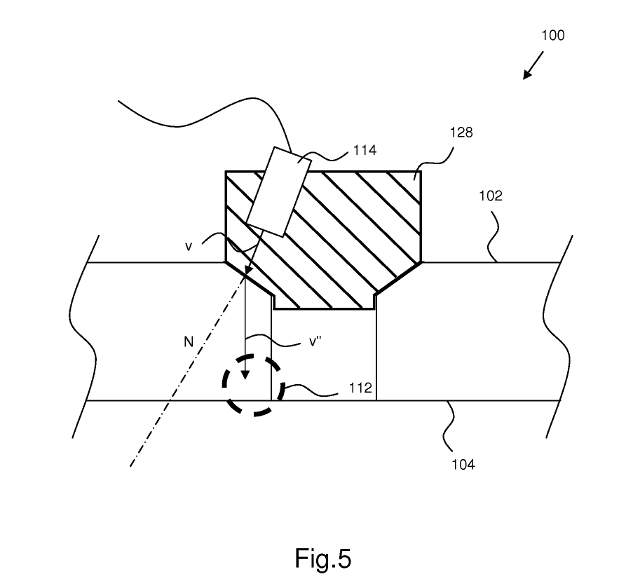

FIG. 5 is a side section view of the component of FIG. 1 being scanned in accordance with a second embodiment of the present invention.

The prior art methods of FIGS. 2 and 3 have been described above. Turning to FIG. 4, the composite component 100 is shown provided with an insert 120. The insert 120 comprises a male frustro-conical formation 122 and a relatively short projecting cylindrical portion 124. The insert 120 is shaped to fit into the bore 106 with the male frustro-conical portion 122 fitting into the female frustro-conical portion 110 of the bore 106. The male cylindrical portion 124 fits into the female cylindrical portion 108 of the bore 106. A continuous mating contact is therefore defined between the component bore 106 and the insert 120 shown as boundary surface 126. Preferably, there are no air gaps along the boundary 126. The insert 120 is a press-fit into the bore 106. In order to ensure adequate sonic coupling, the workpiece 100 and insert 120 may be immersed in a couplant liquid (e.g. water) whilst scanning takes place.

The insert 120 is constructed from material which is acoustically matched to the workpiece 100. For example, for a CFRP (carbon fibre reinforced polymer) workpiece 100, the material of the insert 100 may be formed from a plastic with a similar density to CFRP with a speed of sound within 4% of that of CFRP. The material may be constructed from epoxy or polyester, both of which have a speed of sound similar to that of CFRP.

As shown in FIG. 4, as the scanning vector V passes the boundary surface 126, it is refracted slightly towards the normal N by an angle of a few (typically 2) degrees due to the slight difference in the speed of sound of the insert 120 and the workpiece 100. Because the materials are acoustically matched, this angle is not significant and, as such, the resulting adjusted vector V′ is close to the angle of the scanning vector V. As such the region 112 can be scanned successfully. The reflected sound waves are measured by the probe 114 to detect any faults in the first region 112 of the workpiece 100.

Turning to FIG. 5, an alternative set-up is shown in which the ultrasonic probe 114 is moulded into, or insertable into a cavity in an insert 128.

The insert 128 is constructed from material with a significantly different speed of sound to the CFRP workpiece 100 (in this case the speed of sound of the insert 128 is somewhat lower than the workpiece 100), for example it may be constructed from rubber.

The ultrasonic probe 114 is mounted within the insert 128 at an angle to accommodate for the fact that the scanning vector V is refracted away from the normal vector N to provide an adjusted scanning vector V″ which is directed normal to the interior surface 104 of the workpiece 100. As such, the region 112 can be scanned.

The insert 128 is axisymmetric, and as such it can be rotated to scan the circumference of the bore 106.

It will be noted that although the technique of FIG. 5 produces a useful scan, the advantage of the insert of FIG. 4 is that the probe 114 can be swept along the surface of the workpiece 100 without interruption.

Variations fall within the scope of the present invention. For example, the insert may be formed to suit any required shape of female formation within the workpiece 100. The “countersnk” formation need not be frustro-conical in nature, and may be, for example, a cylindrical formation of larger diameter than the main bore, having an annular shoulder between the two, such a formation being suitable to receive an alien-key type fastener.

Other materials may be used to form the insert as long as the ultrasonic probe is adjusted in orientation to ensure that the adjusted scanning vector is approximately perpendicular to the plies of the component.

1. A method of inspecting a component comprising the steps of:
providing an ultrasonic transducer,
providing a component to be inspected defining a countersunk bore, which countersunk bore defines a countersunk formation open to a first surface of the component, the component having a first region to be inspected on an opposite side of the countersunk formation to the first surface in a direction perpendicular to the first surface,
providing an insert defining a male feature corresponding to the countersunk formation,
engaging the male feature in the countersunk formation to define a boundary between the component and the insert,
directing ultrasonic energy from the transducer, through the insert, across the boundary and into the first region of the component,
inspecting the first region of the component by detecting the ultrasonic energy.

2. A method according to claim 1 in which the component is constructed from a laminar composite material, and the countersunk bore is oriented perpendicular to layers of the laminar composite.

3. A method according to claim 1 in which the insert defines a scanning surface which is parallel to the first surface of the component in use.

4. A method according to claim 3 in which the scanning surface is flush with the first surface of the component.

5. A method according to claim 1 in which the insert is constructed from a material having a speed of sound similar to that of the component.

6. A method according to claim 5 in which the speed of sound of the insert is within 10% of the speed of sound of the component.

7. An apparatus for inspecting a composite component comprising:
an insert having a male formation corresponding to a countersunk formation for engaging a corresponding countersunk formation of a composite workpiece bore, the insert having a scanning surface for contact with an ultrasonic probe.

8. An apparatus according to claim 7 in which the male formation comprises a cylindrical portion for engaging in the composite workpiece bore.

9. An apparatus according to claim 7 in which the male formation defines an axis, and the scanning surface is perpendicular to the axis.

10. An apparatus according to claim 9 in which the insert is shaped such that, in use, the scanning surface is flush with a surface of a workpiece in which the bore is defined.

11. An apparatus according to claim 7 in which the insert is primarily constructed from a material having a speed of sound similar to that of CFRP.

12. An apparatus according to claim 11 in which the insert is primarily constructed from epoxy resin or polyester.

13. An apparatus according to claim 7 in which the insert defines a probe receiving formation for receiving a probe in a predetermined position relative to the male formation.

14. An apparatus according to claim 7 in which the insert is axisymmetric.

15. (canceled)

16. (canceled)
